(19) United States
(12) Patent Application Publication
(10) Pub. No.: US 2005/0180587 A1
(43) Pub. Date: Aug. 18, 2005

(54) Equalizable active electroacoustic device for panels, and method of converting the panels and assembling the devices

(75) Inventors: Alejandro Jose Lopez Bosio, F Oeste Grupo G Quejido (ES); Hernan Humberto Rojas Castillo, F Oeste Grupo G Quejido (ES)

Correspondence Address: BIRCH STEWART KOLASCH & BIRCH, PO BOX 747, FALLS CHURCH, VA, 22040-0747, US

(73) Assignee: Electronica Integral De Sonido, S.A., Zaragoza (ES)

(21) Appl. No.: 10/506,799

(22) PCT Filed: Oct. 11, 2002
(86) PCT No.: PCT/ES02/00480

(51) Int. Cl. H04R 25/00; H04R 1/00

(52) U.S. Cl. 381/150; 381/431; 381/152

(57) ABSTRACT

Electro-acoustic device, which installed in flat-top panels, partitions or facings existing in the market, be they of mineral fibre, plasterboard, plywood, etc., transforms them into planar and invisible radiators of high fidelity sound and spherical dispersion. Through its particular property of being equalisable for each type of panel by means of an electronic equaliser and by having the necessary means to avoid any resonance.

### OBJECT OF THE INVENTION

The object of the present invention is an equalisable active electro-acoustic device which applied to commercial flat-topped panels, of partitions or facings, transforms them into flat and invisible radiators of high fidelity sound and spherical sound dispersion, that is, it relates to the electro-acoustic transducers applied to environmental sound.

Its field of use is very wide, comprising public or private spaces like shopping centres, airports, hospitals, supermarkets, churches, offices and residences, etc.

Thus with the present device the intention is that the actual commercial panels used in construction become elements which disseminate high fidelity sound with the characteristic of not being visible.

Therefore the present invention falls within the field of sound dissemination as well as within the field of the flat-topped panels, partitions or facings of those commercially employed.

### BACKGROUND OF THE INVENTION

The cone and moving coil loudspeakers are very old and since their invention have evolved very little. Until today they retain the system of a cardboard or paper cone that is driven by a coil positioned in a strong magnetic field, which coil on being excited with an AC source makes the cone vibrate reproducing thereby the sound.

The applicant himself has a patent requested in Chile with application number 2598-93 wherein an electromechanical and electromagnetic device is described which allows a flat-topped panel or sandwich type panel of plaster and cardboard commercially known as Pladur® to be transformed into a high fidelity electro-acoustic transducer.

In the device object of the patent ES 9902598, diverse constructional parameters, like form and dimensions of the contact surfaces with the panel have been used, as well as the nature of the adhesives for adhering it thereto. The dimensions, shape and type of the materials of the component pieces especially of the coupler to achieve an electro-acoustic device of high sound efficiency. With all this a flat sound radiator has been achieved with broad sound dispersion and invisible in the place wherein it is installed.

The drawback of the object described in said patent is that of having to have an adapter specially designed for each type of panel in order to obtain optimum equalisation thereof. Also with said system a zero resonance system is not obtained.

Therefore the objective of the present invention, is that of overcoming the previous drawbacks, developing for this an equalisable and active electro-acoustic device which does not required the use of an adaptor specially designed for each type of panel on which the device is located, but which instead has some means of electronic equalisation, which make the equalisation depend on the panel employed (the equalisation is adjustable and tabulated for each type of panel).

Furthermore it is also an object of the present invention to achieve zero resonance of the panel on which the device is mounted and for this, through the special design of the parts in contact between the device and the panel it is possible to generate high fidelity sound of zero resonance.

### DESCRIPTION OF THE INVENTION

The object of this invention, consists of an electro-acoustic transducer device or Motor, associated with an equaliser amplifier which is mounted on the back of any type of panel. Said panels can be commercial flat-topped panels, of partitions or facings, manufactured in mineral fibre, plasterboard or plywood of up to 8 mm and which with the application thereto of the aforementioned device, become invisible planar high fidelity radiators from 100 to 20,000 Hz±3 dB and have an efficiency of 94 dB/W/m.

With the object of obviating the employment of different adapters between the electro-acoustic transducer and each type of panel, an individual equalisation is carried out electronically depending on the type of panel on which the device is fitted. That is, this motor-amplifier-equaliser device is an active system and the panel finally obtained is a high fidelity loudspeaker. By varying the electronic equalisation of the amplifier-equaliser, the coupling is achieved of the device to the different materials selected as invisible radiators.

The motor is common to all the couplers and has been designed so that it is able to reproduce the complete sound range of 100 to 20,000 cycles with a high electro-acoustic conversion efficiency.

With the object of achieving zero resonance in panels with audible resonance, such as plaster or stucco, some pieces of high-density polyurethane foam are mounted on the back of the panels, eliminating the characteristic resonance of the panels and a neutral sound radiator is obtained. Furthermore and with the object of assisting in the attainment of said zero resonance, the feet with which the motor is attached to the panel are independent of the casing of the motor and are of special design. Inside said feet are elastic couplings, vibration dampers, on which the motor rests.

With the aim of obtaining a perfect response of the system at low and at ultra-low frequencies, it is fitted with a subwoofer (loudspeaker capable of reproducing low and sub-low notes with efficiency and spherical dispersion) which includes its own equaliser amplifier, achieving thereby a response from 20 to 100 Hz of excellent quality, it being possible for said subwoofer to be hidden with the sole requirement of having an output port of 5 cm in diameter in the flat top of the location where the panels have been installed.

The procedure by means of which the conversion of the commercial flat-topped panels, of partitions or facings is carried out, into planar and invisible radiators of high fidelity sound comprises the following steps:
a.—Analysis of the response or acoustic behaviour of the selected panel when the electro-acoustic transducer or motor and the assembly of polyurethane foams, should these be necessary, are mounted thereupon.
b.—Design of the equaliser appropriate for the type of panel selected.
c.—Verification of the panel, motor-amplifier-equaliser assembly with laboratory instruments.
d.—Definition of the appropriate equaliser-amplifier for the panel selected.

As for the procedure for assembly of said electro-acoustic devices, or motors, on the commercial panels to transform them into planar and invisible radiators of high fidelity sound, it comprises the following steps:
In the first place a template is placed on the back of the panel. Said template is slightly adhesive in order to be able to remove the template later. On said template a series of perforations have been made coincident with those of the five points of connection, the four of the feet and that of the coupler.
Next a 10-minute epoxy adhesive is applied on the holes revealed by the template.
The template is removed.
Between the motor and the coupler is placed an additional piece or wedge for positioning, which serves to position the coil in height with respect to the panel.
The motor is attached with the five fastening points coinciding with those in the panel, wherein the epoxy adhesive has been applied.
Wait ten minutes for the epoxy adhesive to cure.
Remove the additional positioning piece of the coupler, before beginning to use.

It is important that the device is secured to the panel with 10-minute epoxy adhesive, since the amplifier-equaliser delivers an electric signal to the motor, which signal is equalised and processed so that, depending on the type of panel, the latter produces the correct sound.

This is important since the 10-minute epoxy adhesive has a hardness and speed of sound propagation which are preestablished parameters, as well as the entire design of the motor, the moving coil and the coupler. Respecting all the aforementioned parameters, superlative sound, duration and invisibility are achieved.

### DESCRIPTION OF THE DRAWINGS

Other characteristics and advantages of the present invention will become more evident in the following detailed description of the preferred embodiment of the invention, with reference to the drawings that accompany, wherein:

FIG. 1 represents a cross-section of the electro-acoustic transducer device, secured on the back of a panel.

FIG. 2 shows the previous transducer in perspective.

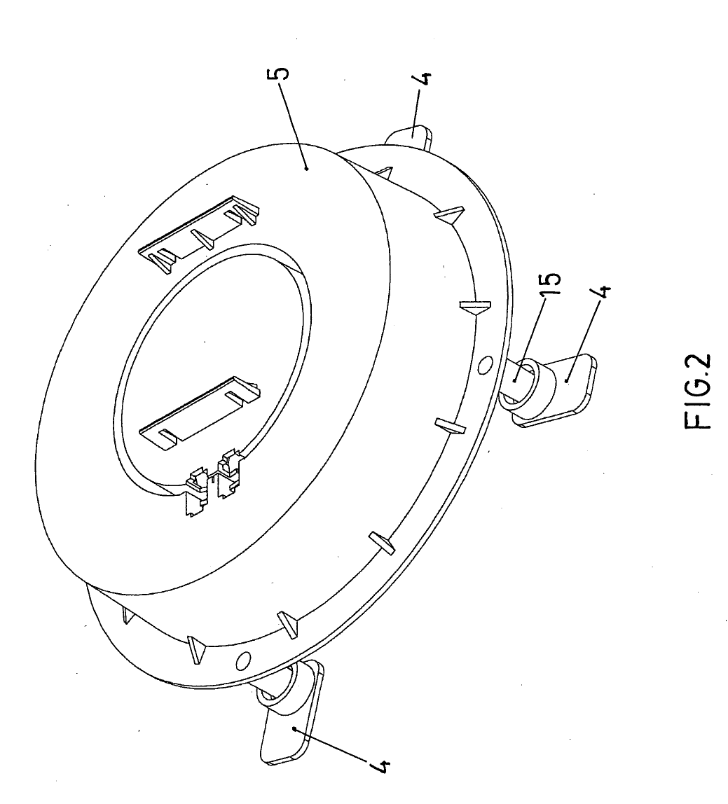

### PREFERRED EMBODIMENT OF THE INVENTION

For a better understanding of the aforementioned drawings, a description follows of all the elements that configure and allow implementation of the embodiment of the invention.

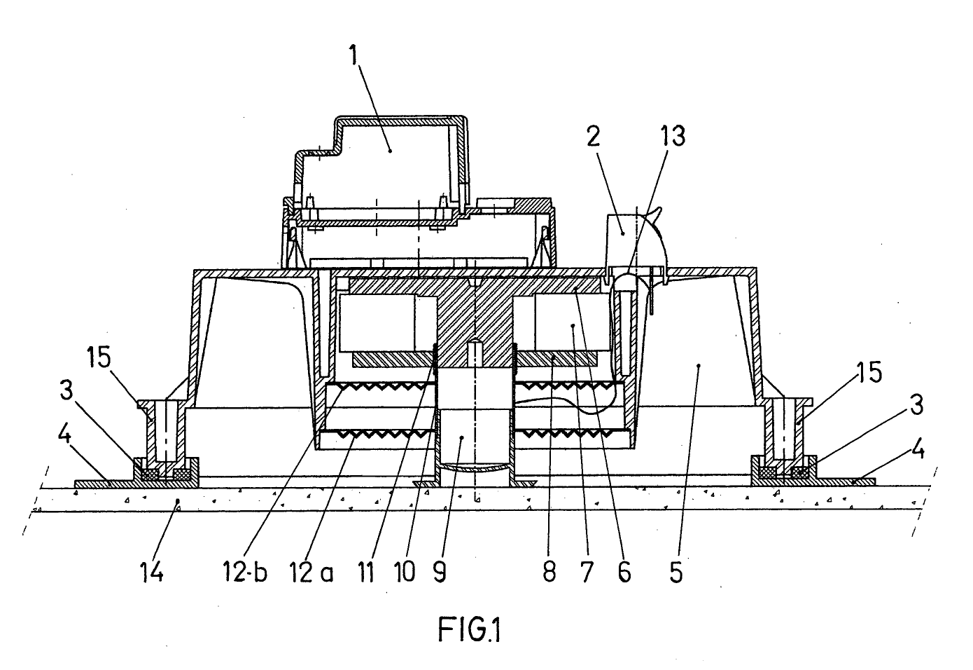

In FIG. 1, it can be observed how the active electro-acoustic device is formed by an amplifier (1) which forms part of the chassis (5). On the chassis are installed the main magnetic polar piece (6), the magnet (7) and the secondary polar piece (8).

All this assembly has an air gap (11) wherein centred axially and laterally a moving coil (10) is mounted, being suspended by means of the hangers or suspension elements (12a) and (12b). Furthermore the moving coil (10) is firmly attached to the adapter piece (9). The electric connection of the assembly is made through the flexible leads (13) to the plug (2).

For the attachment of the motor to the back of the panel (14), the device has four feet (4), which serve both for securing to the chassis (5) through its own feet (15), and as a means of housing the elastic couplers (3) interposed between the feet (4) stuck to the back of the panel (14) and the actual feet (15) of the motor.

The invention, within its essential nature, can be put into practice in other forms of embodiment which differ in detail from that explained by way of example in the description, and to which will extend equally the protection that is claimed. Likewise, it will be possible to build in any form and size with the most appropriate materials, all this being comprised within the spirit of the claims.

1. Equalisable active electro-acoustic device applied to commercial panels, CHARACTERISED through transforming into elements radiators of high fidelity sound flat-topped panels, partition walls or facings existing in the market of diverse materials, such as: mineral fibre, plasterboard, plywood, etc. without requiring the use of adapters specially designed for each type of panel, for which it has an electromagnetic transducer or motor and an amplifier-equaliser specially designed for each type of panel, achieving a linear response, it also has the means necessary to effect the attachment of the motor to the back of the panel, having five contact areas between the device and the back of the panel, obtaining neutral sound radiator elements, with response from 100 to 20,000 Hz±3 dB and efficiency of 94 dB/W/m.

2. Equalisable active electro-acoustic device applied to commercial panels, according to claim 1, CHARACTERISED in that the amplifier (1) is mounted on the motor through the chassis (5). On said chassis have been installed the main magnetic polar piece (6), the magnet (7) and the secondary polar piece (8). All this assembly has an air gap (11) wherein centred axially and laterally a moving coil (10) is mounted, being suspended by means of the hangers or suspension elements (12a) and (12b). Furthermore the moving coil (10) is firmly attached to the adapting piece (9), through which (adapting piece (9)), the vibrations are transmitted to the panel (14). The electric connection of the assembly is implemented by means of the flexible leads (13) to the plug (2).

3. Equalisable active electro-acoustic device applied to commercial panels, according to claim 1, CHARACTERISED in that the means of attachment of the motor-amplifier-equaliser assembly on the back of the panel (14), consists of some feet which are stuck to the back of the panel (14) by means of a 10-minute epoxy resin. Inside said feet, are mounted some elastic couplers (3) whereon the assembly rests by means of the actual feet (15) of the device. These feet, elastic and damped, constitute the main mechanisms of the device for the elimination of the characteristic resonances of the panel where it is applied.

4. Equalisable active electro-acoustic device applied to commercial panels, according to claim 1, CHARACTERISED in that to obtain a neutral sound radiator in the panels with audible resonance, such as plaster or stucco, on the back of the panels some pieces of high-density polyurethane foam are mounted which eliminate the characteristic resonances of the panels. These pieces of foam, constitute the secondary mechanism for elimination of the characteristic resonance of the panel.

5. Equalisable active electro-acoustic device applied to commercial panels, according to claim 1, CHARACTERISED in that the electromagnetic transducer assembly or motor and the amplifier-equaliser have five points of connection with the back of the panel, wherein four correspond to bearings or supports of the perimeter, while the fifth support is that of the adapter which connects the coil to the panel and produces the sound vibration of the panel.

6. Equalisable active electro-acoustic device applied to commercial panels, according to claim 1, CHARACTERISED in that as an extension of the proposed system a subwoofer is mounted which has its own amplifier obtaining a response from 20 to 100 Hz to finally obtain an overall response of the system from 20 to 20,000 Hz, with a neutral (high fidelity) transducer.

7. Equalisable active electro-acoustic device applied to commercial panels, according to claims 1, 2, 3, 4, 5 and 6, CHARACTERISED in that it is intrinsically, a planar sound transducer, with the inherent property of spreading the sound, produced by it, in spherical and not conical form (like loudspeakers) making it much more efficient, each device thereof being capable of replacing effectively, 3 or more loudspeakers in an environment with this sound system installed.

8. Procedure for conversion of commercial flat-topped panels, of partitions or facings into planar and invisible high fidelity sound radiators, CHARACTERISED in comprising the following steps:
a. Analysis of the response or acoustic behaviour of the selected panel when the electro-acoustic transducer or motor and the assembly of polyurethane foams, should these be necessary, are mounted thereupon.
b. Design of the appropriate equaliser for the type of panel selected.
c. Verification of the panel, motor-amplifier-equaliser assembly with laboratory instruments.
d. Definition of the appropriate equaliser-amplifier for the panel selected.

9. Procedure for mounting the assembly formed by the electro-acoustic devices or motors and the amplifier-equalisers on the panels to transform the latter into planar and invisible radiators of high fidelity sound, comprising the following steps:
A template is placed on the back of the panel. Said template is slightly adhesive in order to be able to remove the template later. On said templates there is a series of perforations coincident with those of the five points of connection, the four of the feet and that of the coupler, which join the coil to the back of the panel.
Next a 10-minute epoxy adhesive is applied on the holes revealed by the template.
The template is removed.
Between the motor and the adapting piece is placed an additional piece or wedge for positioning, which serves to position the coil in height with respect to the panel.
The motor is attached with the five fastening points coinciding with those on the back of the panel, wherein the epoxy adhesive has been applied.
Wait ten minutes for the epoxy adhesive to cure.
Remove the additional positioning piece or wedge positioning the height of the coil with respect to the panel before beginning to use.
Wait 15 minutes before making full use of the mounted assembly.
